(19) United States
(12) Patent Application Publication
(10) Pub. No.: US 2012/0167802 A1
(43) Pub. Date: Jul. 5, 2012

(54) Temperature-Adjusted and Modified Recycled ASCON Composition for Reusing 100% of Waste ASCON for Road Pavement, and Method for Manufacturing Same

(76) Inventor: Jung Do HUH, (US)

(21) Appl. No.: 13/414,466

(22) Filed: Mar. 7, 2012

Related U.S. Application Data
(63) Continuation of application No. PCT/KR2009/005043, filed on Sep. 7, 2009.

(51) Int. Cl. C04B 24/36; C08K 3/00; C04B 16/00

(52) U.S. Cl. 106/669; 106/668; 106/671; 524/8; 524/7; 524/4; 524/5; 521/149; 521/148

(57) ABSTRACT

The present invention provides the composition of the modified RAP-recycled warm mix asphalt, whose composition is characterized as consisting of a mixed asphalt concrete mix, a cohesive agent, a recycling modifier, a plasticized warm mix additive, and if necessary, reinforcing agent will be added to the composition. The aforementioned composition can be mixed to produce the modified RAP-recycled warm mix asphalt. This invention is characterized in reusing a great portion of RAP compared to the less use in the existing practice. The use of a recycling modifier improves further better performance properties to extend the life cycle of recycled asphalt pavements, compared to the conventional virgin asphalt pavements as well as the existing recycling ones. The plasticized warm mix additives offer economic, social, and technical advantages by saving the fuel consumption required for production, reducing greenhouse gas emissions, and shorten traffic opening times.

This Application is a Continuation of International Application No. PCT/KR2009/005043, filed Sep. 7, 2009.

### TECHNICAL FIELD

An asphalt concrete mix is a composite material produced by mixing asphalt binder, coarse aggregate, fine aggregate and mineral filler at a high temperature (around 160° C.), and is commonly used in such construction projects as paving of roads, airport runways, and parking lots, etc. The asphalt binder in those pavements gradually reacts with oxygen from the atmosphere, loses flexibility, and becomes hardened during pavement service period. This reaction process is called oxidative aging, and if oxidative aging persists over a long period of time, it causes serious surface cracking due to brittleness of pavements and eventually fails the pavement function by ending its life cycle.

A considerable amount of waste asphalt concrete mix (or reclaimed asphalt pavement; RAP) is generated during construction of overlays for damaged asphalt pavements (e.g., deep rutting or fatigue cracking), new extension of traffic lains from the existing ones, excavation of pavements for burying sewer pipes, electrical wires or cables under pavements, and a full reconstruction of old pavements,. Since such RAP produced has been already exposed to air for an extended period of time, they essentially contain aged asphalt binder by oxidation that became very hard.

Reusing RAP in pavement construction requires appropriate treatment to soften the oxidatively aged hard asphalt binders. Physical properties of regenerated asphalt mixes by simply mixing RAP with virgin mixes are deteriorated further, if content of RAP is increased. This may cause serious early pavement cracking. Thus, in the past, RAP has been disposed as landfilling or underground-burying. Recently, however, there has been growing awareness of RAP as a valuable resource, and every country around the world is strongly pushing forward to reuse RAP for pavement construction for a number of reasons, such as preventing land pollution, saving valuable construction materials (asphalt binders and aggregates), and reducing construction material costs by using inexpensive RAP.

The existing technology of recycling RAP widely accepted worldwide, has failed to fulfill expectation of recycling demands due to the low usage of RAP and the poor quality of pavements obtained. The present invention includes a new composition of RAP-recycled asphalt concrete mixes that uses more RAP, assures an excellent physical properties, and thus causes less pavement problems.

### BACKGROUND

The existing technology of RAP-recycling in pavements aims to restore the original properties of asphalt mixes by combining RAP, a virgin asphalt concrete mix (new aggregates, new asphalt, and fillers), and a rejuvenator. However, the majority of RAP-recycled asphalt pavements constructed by the existing recycling technology show inferior quality and fail to satisfy expectation of recycling demand. The role of the rejuvenator in the existing technology is to soften the hardened RAP, but unfortunately it cannot improve the quality of the recycled mixes. Also the mix design for RAP-recycling is done prior to recycling process, but the actual production takes place afterwards at a high temperature.

This produces quality difference between the design quality and the actual one, because further oxidiation of recycled mixes occurs at the high temperature production. A common practice to solve this problem is to increase the amount of asphalt binders to prevent early cracking. However, this creates softness of pavements during summer time that can cause pavement rutting. In another words, the existing recycled pavement technology has an inherent limitation that can cause either cracks or rutting according to content of asphalt binders. This limitation of the existing recycling technology must be overcome to be used in major traffic roads.

This is why the recycling industry uses only a small portion of RAP (usually less than 20 wt %) added to a major portion of a virgin asphalt mix to prevent quality deterioration originated from RAP addition. The more the RAP is added to virgin materials, the more the quality deterioration of recycled pavements is inevitable. For an example, in the case of recycled pavements used as major road pavements, contents of RAP are limited to be less than 30 wt %. In the U.S., the use of more than 20 wt % of RAP is considered to be highly used for major roads. The limited use of RAP raises the need to solve such problems of continual accumulation of unused RAP, high cost of waste disposal, land pollution caused by the accumulated RAP and the dwindling natural resources. The usage of more RAP material in pavement construction helps to solve the issues mentioned above.

In the conventional hot recycling process, whether it is a batch-type or a continuous drum-type, a large amount of virgin hot mix asphalt and a small amount of RAP are mixed together at a range of 160 to 170° C. to yield recycled hot mix asphalt. Such a recycling method, however, involves a problem of the high fuel consumption to produce recycled asphalt mixes at high temperatures. The high temperature production generates a considerable amount of the greenhouse gas emission, and involves drastic oxidative aging (the higher is the temperature, the more the oxidative aging that causes brittleness of asphalt materials occurs.).

In short, the drawbacks of the existing RAP recycling technology are: use of the relatively small amount of RAP, poor quality of the recycled hot mix asphalt and the high temperature production. These problems demand a sensible solution.

The prior patents in the area of recycled hot mix asphalt can be summarized as follows: Under Korean Patent No. 0317436, the mix ratio of RAP to virgin materials is limited to 30-50 wt %. To improve properties of recycled hot mix asphalt, it is suggested that SBR latex, EVA, SBS, SIS, or crumb rubbers with a maximum size of 2 mm are melted in asphalt binders at a high temperature together with a rejuvenator. The claimed method not only limits the content of RAP to 30-50 wt %, but also lessens the modification effect of polymer modified asphalt binders by the dilution of the additional old-asphalt binder in RAP, thereby the desired enhancement of properties is not met. The method also does not take into consideration of solving the high fuel cost associated with raising the high production temperature, harmful gas emission and oxidative aging, etc.

Another solution worthwhile to mention is Korean Patent number 0284998. Its method used fly ash and organic fibers to enhance properties of RAP-recycled pavements and even though it uses RAP, its actual deployment in production is yet limited. Materials like fly ash and organic fiber are fillers that help improve physical properties of a recycled mix. But they have no added effects to chemical properties and the overall quality is not improved a lot. Another downside to this process is that it requires additional equipment for the fillers to add to the mix. And yet environment pollution associated with emission of gas produced at high production temperature still prevales.

Another Korean Patent registered as No. 0781608 proposes 100% use of RAP with a recycling modifier to obtain the excellent properties of recycled asphalt concrete mix. The invention is considered to show a more advanced technique. However, it poses an adverse situation of the possibility of shortage in RAP with mass production. It also does not provide a clear solution relating to high production temperature, i. e., oxidative aging, fuel cost and greenhouse gas emission, etc.

### DETAILED DESCRIPTION OF INVENTION

### Technical Problem

In the existing RAP-recycling technology, 30 wt % or less of RAP and 70 wt % or more of virgin asphalt concrete mixes are mixed together with or without a rejuvenator of 2-6 wt % to meet the composition of the RAP-recycled hot mix for a pavement surface layer. The amount of RAP added is limited to be less than the virgin hot mix asphalt because the existing method is designed to minimize the loss in quality of the recycled asphalt pavement. If the recycled hot mix asphalt containing more RAP than the virgin, which means an increase in oxidatively aged asphalt, it will unavoidingly yield to more hardened pavements. The hardened pavement becomes more susceptible to cracks. This causes the life span of the pavement to become considerably shortened. This technical downfall must be resolved by using less RAP in the recycled pavements.

The existing recycling method suggests using enough virgin asphalt binder with small amount of RAP to lower the high viscosity of RAP binder, or adjust to a desired viscosity through use of both an asphalt binder and a rejuvenator. In this practice, the lowered viscosity does help reduce early pavement cracking, but can cause another problem known as pavement rutting. In summary, the present recycling technology cannot avoid the persisting issues of either rutting or cracking.

The recent technical trend of RAP-recycled pavement has been gravitating towards using modified asphalt binders or/and modified rejuvenators. Because modified asphalt binders or rejuvenators produced by adding polymer modifiers has shown better physical properties. However, addition of polymer modifiers to those materials is restricted to be relatively small amount due to rapidly growing viscosity upon addition. The high viscosity prevent from using those materials due to handling problems. Thus, it should be noted that the modified asphalt binder or the modified rejuvenator is added only to the extent of covering new aggregates and RAP particles which limits the amount of modifiers included in those materials. The limited modifiers become diluted further when they mix with the old asphalt binders in RAP. This lessens the effectiveness of the modification further more. Therefore, the idea of adding modified binders is still short in solving current quality issues of RAP-recycled pavements.

Another critical point is that the recycling process has to be implemented at a high temperature (160-170° C.), causing problems such as harmful gas emission, consumption of more fuel, and aging by oxidation. In order to solve these production problems, a warm mix additive or an asphalt emulsion is added to produce the recycled hot mix asphalt at moderate temperatures (120-140° C.). However, because the recycled hot mix asphalt containing modifiers usually show considerably higher viscosity, the quantity and the selection of warm mix additives to reduce the production temperature have become important issues to be resolved.

To finalize, the aforementioned existing RAP recycling technology has shortcomings of, first, limitation of using less RAP, second, poor quality of recycled pavements, and, third, high temperature production.

### Technical Solution

To solve the technical problems pointed out in the previous section, this invention suggests the composition of the modified recycled warm mix asphalt characterized as consisting of 100 parts by weight of mixed asphalt concrete mix with aggregate distribution below 50 mm, 0.1-8.0 parts by weight of cohesive agents, 0.3-2.0 parts by weight of recycling modifiers, 0.1-1.0 parts by weight of plasticized warm mix additives, and if necessary, 0.1-2.0 parts by weight of reinforcing agents. The resulting mix can be used as wearing course, a surface layer, an intermediate layer, and a base layer of asphalt pavements.

The following statement is the description of the characteristics of a mixed asphalt concrete mix among the compositions of the aforementioned modified recycled warm mix asphalt. The 100 parts by weight of mixed asphalt concrete mix refer to consisting of a selected part by weight of RAP and the other part by weight of the virgin asphalt concrete mix, whose sum becomes 100 parts by weights. When RAP alone occupies 100 parts by weight, no virgin asphalt concrete mixes exist in the mixed asphalt concrete mix. Conversely, if the virgin mix alone occupies 100 parts by weight, this means that no RAP is contained in the mix.

It is most desirable to use 100 parts by weight of RAP as a mixed mix in the view of preserving natural resources, eliminating land pollution, and reducing material costs. However, the maximum usage is sometimes difficult to be achieved, because the use of RAP alone does not meet aggregate gradation requirement, and some production facilities are only set up to mix both virgin materials and RAP together, and the insufficient stockpiled RAP necessitates the addition of virgin asphalt concrete mix to fulfill the daily production demand. Inspite of these circumstances, RAP should be still used as much as possible to reduce construction costs and environmental pollution. Note that this invention also includes the compositions of new modified warm mix asphalt only by using100 parts by weight of virgin asphalt concrete mix without any RAP.

It is noted that there exist two different procedures in making the mixed asphalt concrete mix. The first method is to make a certain weight part of the hot virgin asphalt mix by mixing hot aggregates, a hot liquid of an asphalt binder and fillers at a high temperature. Then the virgin hot mix is mixed with a certain weight part of the heated RAP. The second method is to enter all ingredients of a certain mixed asphalt concrete mix including RAP into the mixing chamber and mixes together at the same time at a high temperature.

RAP (Reclaimed Asphalt Pavements) refers to construction waste materials generated from maintenance or the reclamation work of aged or damaged asphalt pavements. RAP is obtained in various shapes: blocks, chunks, lumps, or relatively small particles usually smaller than 26 mm obtained from cold or hot milled process. Big blocks, chunks or lumps of RAP are crushed and separated into different particle sizes below 50 mm, which are stored separately to be used for particle-size distribution of a certain mixture.

Hot-milled RAP, obtained from heating and scraping pavement surfaces at construction sites, can be reused immediately before cooling-down without any particle size adjustment.

Meanwhile, cold-milled RAP, produced from cold milling of pavement surfaces, may partially contain crushed particles that are produced during milling. It can be reused as it is, but it is desirable to compose the RAP to be 56 to 66 wt % of remains and 34-44 wt % of passings after sieving through a 2.3 mm sieve. This procedure will allow the cold-milled RAP to possess a relatively consistent aggregate gradation (or the consistent asphalt content). If the less than 56 wt % of the RAP particles remains on the 2.3 mm sieve, it implies that the RAP consists mostly of fine particles. If the more than 66 wt % of the RAP particles remains on the sieve, it means that the particles have too many coarse aggregates. It is noted that too many fines contain relatively more asphalt binders that can cause easy rutting, while too many coarses include less asphalt binder that can cause relatively easy fatigue cracking. Thus, controlling particle size and gradation is a critical key in producing a consistent mix.

All RAP materials with the maximum particle size of below 50 mm can be recyclable in the asphalt pavement construction. The desirable maximum particle size is 50 mm for the base layer, 38 mm for the intermediate layer, 26 mm for the surface layer, 13 mm for the wearing course, 2.5 mm for the mastic, and 0.6 mm for the seal coating, but this suggestion can be changed arbitrarily according to the construction condition or the designer's discretion.

The desirable aggregate gradation of an asphalt concrete mix can be selected from the known gradations such as dense-graded, coarse-graded, fine-graded, Superpave graded, porous graded, gap-graded, open graded, and SMA (Ston Matrix Aggregate) graded aggregates. A mix designer can design his/her own aggregate gradations for recycled asphalt concrete mixes if necessary. In the mix, the designer may decide the quantity of each component for modified, recycled warm mix asphalt such as RAP, new asphalt concrete mix, cohesive agent, recycling modifier, and plasticized warm mix additive to the extent of producing the optimal testing result among many mix specimens made from varying quantities of each component and aggregate gradations.

The following statement describes characteristics of a cohesive agent comprising the aforementioned modified recycled warm mix asphalt. The existing technology uses large amounts of virgin asphalt concrete mix with relatively small amounts of RAP to produce the recycled hot mix asphalt. Contrary, this invention uses large amounts of RAP with small or no amounts of virgin asphalt mixes. Even100% RAP recycling is possible through this invention.

One key factor of this invention differing from the existing is to use a cohesive agent to combine all particles in the recycled mix. The concept of using a cohesive agent is markedly different from the existing one that tries to focus on restoring the original properties of the virgin asphalt binder by using a rejuvenator. The existing and the new technology both attempt to lower the viscosity of recycled mixes, but their goals are different. The clear difference between the two is that the existing technology uses a virgin asphalt binder and a rejuvenator to soften the hardened viscosity of old asphalt binder in RAP and to make the original viscosity prior to be hardened by oxidation, while the new technology uses a cohesive agent to soften the high viscosity of the old asphalt binders in RAP to combine all the particles together in the asphalt concrete mix.

Here, cohesive agents are a broad range of melts or liquids including asphalt binders, their solvents, rejuvenators and various oils that can dissolve old asphalt binders in RAP. Cohesive agents should have characteristics to dissolve old asphalt binders in RAP at a high temperature to make hot melts, and these hot melts, in turn, are mixed with new asphalt binders to produce a homogeneous regenerated asphalt binder, and this regenerated binder binds all aggregate particles together. The detailed mechanism of making a cohesioned mix from RAP-particles by using a cohesive agent will be followed.

If one heats RAP materials to a high temperature during production, firstly, the more oxidation of the old asphalt binder in RAP takes place to increase its viscosity to be even higher. This causes almost no movement of the old asphalt binder coated on the aggregate surfaces even if it is well melted.

Secondly, the RAP particle at a high temperature usually consists of the solid aggregate inside, the old asphalt binder coating the aggregate and the air outside. Since the melted old asphalt binder has a higher chemical affinity on the inner aggregate than the outer air, it adheres strongly to the inner aggregate and stays away from the air. This tendency makes the shape of the RAP particle be spherical during the high temperature mixing to minimize the contact area of the coated binder against the outside air.

Thirdly, the spherical RAP particles behave separately each other due to the air barrier around each particle. These three reasons make the melted RAP particles highly difficult to be adhesioned together during mixing. This is why the early cracking of recycled pavements constructed from a large amount of RAP is likely happened without adding a cohesive agent due to the lack of adhesion among RAP particles

If a cohesive agent that has characteristics of low viscosity and high compatibility with old asphalt binders is added to the heated RAP, it is dissolved into the old asphalt binder to make, the high viscosity lowered and to let the surface tension between the aggregate and the coated asphalt binder decreased. Note that the high temperature and the low viscosity yield to low surface tension. The decreased viscosity and surface tension at a high temperature disrupts the aggregate-asphalt binder-air structure and let the coated binder be ready to make flow. By the consequence, the easily movable and low-viscous asphalt binder expels the air curtain around particles, and the neighboring RAP-particles can be combined together to form a cohesion.

The content of a cohesive agent required to form cohesion is in the range of 0.1 to 8.0 weight parts in the recycled mix. If the amount of the cohesive agent is below 0.1 parts by weight, it is not sufficient in forming cohesion of RAP particles, and if it is above 8.0 parts by weight, the viscosity of RAP drastically decreases and loses the necessary binding strength among particles. The content may vary, depending on the type or the viscosity of a cohesive agent within the range of the allowable amount. The lower is the viscosity of the cohesive agent, the less is the amount needed due to the thinner coating formed on aggregate surfaces. On the contrary, the higher is the viscosity, the more is required.

At room temperature, the cohesive agent may be either liquid or solid, but at high temperature, its viscosity should be equal to or lower than that of asphalt binders and its flash point should be higher than 180° C.

The group of a cohesive agent includes organic acids (adipic acids, fumaric acids, oxalic acids, maleic anhydrides, stearic acids, oleic acids, palmitic acids, terephthalic acids, lauric acids, etc.), organic acid salts, organic amines, hydrocarbon oils, aromatic processing oils, aliphatic processing oils, aliphatic-aromatic mixed processing oils, heavy oils, various industrial and commercial rejuvenators, BTX (Benzen Toluene Xylene) oils, asphalt binders for road pavements, emulsified asphalt binders, cutback asphalt primers, MMA (methylmethacrylate) solutions, unsaturated polyester, animal oils (cow, pig, fish oils, etc.), vegetable oils (bean, corn, sesame, perilla, coconut seed, coconut cake, palm, palm cake, palm sludge, linseed oil, cotton seed oil, wool plannel cator oil, etc.), animal-vegetable oil mixture, castor oil, mineral oil, bunker C oil, bunker B oil, bunker A oil, glycerol, grease, waxes, waste and refined industrial oils (motor oil, lubricant, rolling oil, heat transfer oil, and mechanical lubricant), refined and wasted shipping motor oils, refined and wasted compressor oils, phosphoric acid, wasted oils of automobile, and all their mixtures, etc.

Now, the detailed explanation of a recycling modifier included in the composition of the aforementioned modified recycled warm mix asphalt will be given below. If a cohesive agent is added into mixed asphalt concrete mix at a high temperature, the adhesioned hot mix asphalt can be produced, but the mix usually shows inadequate physical properties to be used for paving materials of major traffic roads.

To overcome the inferior physical properties, this invention uses another constituent of recycled paving materials called a recycling modifier that is highly compatible with a cohesive agent and a mixed asphalt concrete mix at a high temperature. The main function of this modifier is to improve physical properties of the recycled warm mix asphalt. This modifier relating to property improvement of the RAP-recycling is called a recycling modifier. It consists of various polymers showing excellent physical properties. Such recycling modifiers include diverse thermoplastic polymers and resins, thermoplastic elastomers, many different rubbers and their powders. Among them, one or more materials selected can be served as a recycling modifier.

These modifiers can be divided into elastic, viscous, and viscoelastic materials according to their characteristics. All of them contribute to improve quality of recycled asphalt mixes, but it is desirable to use a viscoelastic modifier as a recycling modifier, which possesses both elastic and viscous properties together. The elastic property of a recycling modifier can enhance the cracking resistance of the recycled pavements and the viscous property can improve rutting resistance.

The aforementioned recycling modifiers should have good compatibility with asphalt binders and cohesive agents, and also coats aggregates well. When a mixed asphalt concrete mix, a cohesive agent, and a recycling modifier are heated and mixed together at a high temperature, the cohesive agent can make the particles in the mix be adhesioned, and the recycling modifier can improve properties of the adhesioned mix. As the result, a modified recycled asphalt mix holding excellent physical properties can be produced. The detailed description about quality improvement of recycled mixes by using a recycling modifier is illustrated in the next.

An asphalt binder generally consists of a large number of chemical compounds that are all different in their chemical structures. These compounds in an asphalt binder are known to exist in a well-dispersed state by forming an emulsion. Each asphalt binder is identified by four major chemical groups; saturated aliphatic hydrocarbons, cyclic aliphatic hydrocarbons, aromatic hydrocarbons, and asphaltenes. These four entities constitute an emulsion at a high temperature called an asphalt binder. Asphaltene molecules are mainly made up of multiple benzene rings that show solid-like hardness. This molecule forms the core of an emulsion. Aromatic hydrocarbons that are more flexible surround the asphaltene core by taking a role of an emulsifier. Around the aromatics, the cyclic aliphatic compounds (naphthenics) that are further softer are clustered outside of the aromatics. The asphaltene, the aromatics and the naphthenics constitute an emulsion cluster. Many clusters are dispersed in the liquid medium of the saturated aliphatic hydrocarbons that take a role of a continuous medium in an asphalt binder at a high temperature. Asphalt binders behave like a homogeneous liquid at a high temperature by forming the emulsified structure mentioned above.

When an asphalt binder in pavements reacts with oxygen in air, it becomes oxidatively aged. Aromatic hydrocarbons, which serve as an emulsifier around asphaltenes, gradually disappear by forming more asphaltenes during oxidation. As the result, the number of aromatic hydrocarbons gradually disappears with progress of the reaction. The decrease of aromatics makes it impossible to maintain the emulsified state. The increased hard asphaltenes with decreased aromatics cause to lose flexibility and increase stiffness of an asphalt binder. The hard asphaltenes act as a molecular solid additive and is a major contributor of increasing viscosity of an asphalt binder. The hardened asphalt binder due to presence of more asphaltenes can bring earlier cracking in the asphalt pavement when repeated traffic loading is applied to.

The existing RAP recycling technology tries to restore the original viscosity and the flexibility by adding more aromatics and volatiles to the hardened old binders in RAP. Here, the aromatics and the volatiles are major constituents of a rejuvenator. Several different ones are commercially available to be used for RAP-recycled mixes. In other words, a rejuvenator made of aromatics and volatiles deficient in the old binder is added with a new binder to soften the high viscosity of the RAP-binder and to restore the flexibility of the original. When an asphalt binder starts to be oxidatively aged, aromatics are decreased and more asphaltenes are generated in addition to the asphaltenes originally present, and thus the viscosity of the aged binder also increases due to more asphaltenes present.

As mentioned above, a rejuvenator (composed of mainly low molecular weight aromatics and some saturated hydrocarbons having relatively short chains) is a type of oil the viscosity of which is relatively low. Addition of such a rejuvenator does not affects asphaltenes present in old asphalt binder, but make possible to obtain the desired viscosity from the old binder by reducing the medium's viscosity (the viscosity of saturated hydrocarbons).

This can create a significant viscosity difference between the phase of the hard asphaltenes and the phase of the oil-like base medium in the internal structure of the old binder. In production during the mixing stage, the hard asphaltene molecules move freely in the low viscous medium and some become locally concentrated. The heterogeneously distributed hard asphaltenes in the binder can become a basic cause of pavement problems like various cracks. Therefore, the existing RAP-recycling technology using a rejuvenator produces a material structure that holds nothing but poor properties.

On the other hand, this invention uses a recycling modifier that provides good adhesion to asphaltenes by modifying viscosity as well as elasticity (viscoelasticity) of the medium. During mixing, hard asphaltenes are well scattered in the modified medium and reinforce the strength of the recycled binder acting as a molecular filler. Whereas asphaltenes in the existing recycling binder have a negative effect on properties, those in the present invention take a positive role as a reinforcing agent in the molecular level.

And it is surprised that the modified recycled binders possess better properties than even virgin modified binders. This is believed to be the known effect of the binder modification by a modifier as well as the added effect of the reinforcement by asphaltene fillers.

Generally, recycling modifiers can be divided into elastic and viscous polymers. Elastic polymers include thermoplastic elastomers and various rubbers, for instance, SBS(Styrene-Butadiene-Styrene), SBR(Styrene-Butadiene Rubber), SEBS(Styrene-Ethylene-Butadiene-Styrene), PU(Polyurethane), SIS(Styrene-lsoprene-Styrene), ABR(Acrylobutadiene Rubber), polychloroprene rubber, butyl rubber, natural rubber, natural rubber solution, SBR latex, crumb rubber, NBR (Nitril Butadiene Rubber), isoprene rubber, EPDM (Ethylene-Propylene-Diene-Monomer Rubber), butadiene rubber, and their mixtures containing more than one of the aforementioned elastic polymers.

Viscous polymers include all thermoplastic polymers, such as high-density polyethylene (HDPE), low-density polyethylene (LDPE), linear low-density polyethylene (LLDPE), polypropylene (PP), CPP (polyethylene-propylene copolymer), elvaloy, PVA(Polyvinylacetate), ethylene-vinyl acetate copolymer (EVA), aliphatic petroleum resin, aromatic petroleum resin, aliphatic-aromatic petroleum resin, PB (polybutene), acrylic latex, nitro-cellulose, ethyl cellulose, Kopel, polyphosphoric acid, rosin, ABS (Acrylo-nitril-butadiene Copolymer), and high impact polystyrene (HIPS), and their mixtures containing more than one of the aforementioned thermoplastic polymers.

However, a recycling modifier made from the above two groups of polymers have a fixed level of viscosity or elasticity provided by the given polymer. If one chooses a specific polymer as a modifier, the modifier fails to obtain different viscous or elastic properties other than the chosen polymer. For example, SBS and SBR have relatively excellent elastic properties but poor viscous properties, while PE and PP have superior viscous properties but have poor elastic properties. Therefore, a desirable recycling modifier proposed in the present invention is required to have a viscoelastic property containing both elasticity and viscosity that resist both cracking and rutting of asphalt pavements.

This goal can be achieved by adding an elastic polymer to a thermoplastic one to design a desirable property suitable to the given traffic and weather condition. If a certain recycling modifier selected from 0.3 to 2.0 weight part is counted to be 100 wt %, this 100 wt % is the sum of two parts; one is the wt % of an elastic polymer selected below 100wt % and the other is the wt % of a viscose polymer selected below 100wt %. In composing the recycling modifier by this way, good compatibility among an elastic polymer, a viscous polymer and an asphalt binder must be assured to prevent material separation.

If only an elastic polymer is used as a recycling modifier, no viscous polymer is present, and, vice versus, if a viscous polymer is only used as a recycling modifier, no elastic polymer is present.

Although some polymer modifiers have been already used in the RAP recycling, they usually well dissolved in asphalt binders, rejuvenators, or asphalt emulsions, and produced in the form of liquids or melts. These forms are called modified asphalt binders, modified rejuvenators, or modified asphalt emulsions. These products improve properties of virgin asphalt mixes, but not markedly those of RAP-recycling ones. These products will fail to provide good modification effect to the recycled mix due to the dilution caused by the extra asphalt binders in RAP in addition to those modified asphalt binders, modified rejuvenators, or modified asphalt emulsions. If one wants to increase the modifier concentration in those materials to correct the the dilution effect, he immediately face with handling problems of those materials because a small addition of the extra modifier will increase their viscosity drastically. Thus, those modified materials will bring the weak improvement of physical properties on the RAP recycling mix.

The present invention involves the separate addition of a recycling modifier that is a solid-particle or powder type into the recycled mix, independently from the addition of a cohesive agent, and thereby the degree of modification can be freely adjusted. The range of addition of a recycling modifier in the present invention is from 0.3 to 2.0 in parts by weight. Any modification below 0.3 parts by weight is ineffective. If one uses above 2.0 parts by weight, the viscosity of a recycled mix is too high to be practical and it is also economically infeasible.

The physical state of a recycling modifier in the present invention is mostly solid particles at room temperature, unlike those well dissolved in asphalt binders, asphalt emulsions, or rejuvenators in the existing technology.

However, modifiers like rubber latex, polymer latex, emulsion, and natural rubber, as well as SBR latex, are in a liquid state at room temperature. Their solid particles should be less than 0.5 mm and can be added with cohesive agents. When a liquid-state modifier is added into a high-temperature mix, the solid residue remaining after evaporation of the liquid medium will be mixed and therefore enough quantity of those materials must be used to ensure good modification effect.

Meanwhile, most recycling modifiers in a solid state at a room temperature should form a homogeneous melt upon mixing with an old asphalt binder and a cohesive agent at a high temperature, only if they can be instantaneously melted upon heating. However, the recycling modifiers which consist of solid particles of organic compounds are known to show poor heat-transfer characters. Hence they require considerable time of heating and mixing before they are melted, especially if the size of the modifier-particle is large. Usually, the mixing time needed to produce the hot mix asphalt at a batch plant is very short (mostly, 40 to 50 seconds) in consideration of a daily paving capacity and fuel costs.

To satisfy the time limit of mixing, the particle size of a recycling modifier must be made into powders or fines to resolve the problem of poor heat transfer and to meet the instantaneous melting. Therefore, the particle size of a recycling modifier is desirable to be less than 3 mm. The particle size in different modifiers can vary according to the speed of melting or the particle thickness. If a modifier melts faster relative to others of the same size, a relatively larger size can be acceptable for the modifier. Reversely, if it takes longer time to be melted, the particle size should get finer. In relation to particle dimensions, the thinner does it become, the longer the length it can be possible.

The following describes characteristics of a reinforcing agent among the composition of the aforementioned modified RAP-recycled warm mix asphalt. A reinforcing agent is used to promote durability and strength of the modified recycled asphalt pavement, and is composed of organic and inorganic fillers and short fibers. Unlike cohesive agents or recycling modifiers, reinforcing agents do not affect chemical properties but change physical properties while they maintain their original shapes. For example, organic and inorganic powders, as fillers, remain in their shapes while they are dispersed inside the recycled mix for reinforcement that prevents rutting. The same is true for short fibers whose length prevents crack propagation.

Such organic, inorganic powers and fillers include carcium carbonate, limestone, aggregate fine, waste toner, silica, bentonite, zeolite, clay, mica, carbon black, slag from steel making, furnace slag, cements, clay, carbon black, fly ash, gypsum, slaked lime, quick lime, plastic refuse-derived fuel (RDF), inflammable refuse-drived fuel (RDF), biomass, organic and inorganic pigments, saw dust, paper powder, powders or chips of waste plastics, and mixtures of these materials.

Short fibers represent nylon fiber, polyester fiber, polyethylene fiber, polypropylene fiber, carbon fiber, cellulose fiber, glass fiber, asbestos fiber, and their mixtures containing more than one of the aforementioned materials.

These reinforcing agents may be added to recycled mix from 0.1 to 2.0 parts by weight. Addition below 0.1 parts by weight may have little effect, while addition over 2.0 parts by weight produces the excessively high viscosity of the recycled mix that cannot be used in practice.

The following sentences describe characteristics of plasticized warm mix additives among the composition of the aforementioned modified recycled warm mix asphalt. Up until now, the composition listed above pertains to the modified recycled hot mix asphalt, but the plasticized warm mix additives are added to produce the modified recycled warm mix asphalt at a moderate temperature (120-140° C.).

If a cohesive agent and a recycling modifier are added to a mixed asphalt concrete mix at high temperatures (170-180° C.) during production, one faces negative consequences such as air pollution, oxidative aging of asphalt binders, and high fuel consumption in raising a high production temperature. Most of these problems can be substantially reduced by lowering the production temperature by 20-40° C., while keeping good performance properties at temperatures of 80° C. below.

For this purpose, the existing technology use warm mix additives. However it is not easy to obtain the warm mix effect only by using warm mix additives for the modified recycled asphalt mix, because the modified concrete mix with recycling modifiers show a lot higher viscosity than the regular recycled asphalt concrete mix. Therefore, a plasticizer that lowers a melting point of a recycling modifier and a warm mix additive that lowers viscosity of asphalt binders can be used together to secure the warm mix production of modified RAP-recycled asphalt concrete mix. Such additives that enable warm mix production through the use of both plasticizers and warm mix additives together are called plastizied warm mix additives.

Of course, increasing the content of either a plasticizer or a warm mix additive each also makes it possible to produce warm mixes. However, the increased content may cause either to excessively lower the mix viscosity even at performance temperatures or to produce side effects such as premature cracking. The present invention, therefore, suggests the use of plasticized warm mix additives for the effective production of the modified recycled warm mix asphalt. Plasticized warm mix additives can be more effective than the existing warm mix additives in generating the warm mix effect for either highly viscous modified recyling mixes or modified virgin mixes.

Plasticizers are organic ester compounds, which are produced by reacting organic acids with various alcohols under presence of catalysts. When a plasticizer is heated and mixed with a polymer modifier, it lowers the melting point and the viscosity of the modifier to make easy to be processed. Most plasticizers display functions similar to solvents of polymer modifiers, but they are different in their relatively larger molecular weight and the higher flash point (the flash point is at or higher than 180° C.) than those solvents.

Plasticizers are characterized to decrease viscosity of polymer modifiers for all temperature ranges, including those of production, construction, and pavement performance. Therefore, the more plastisizers used than the required can cause pavement rutting due to the too much reduced viscosity of a recycling modifier even at performance temperatures. Thus, it is advised to use an appropriate amount.

Generally, plasticizers are organic ester compounds, which are divided into the phthalic acid ester group, the trimellitic acid ester group, the phosphoric acid ester group, the epoxy ester group, the polyester group, the aliphatic acid ester group, and the surface active agent group.

Among them, phthalic acid ester group includes DOP (Di-2-ethylhexyl-phthalate), DBP (Di-butyl-phthalate), DINP (Di-isononyl phthalate), DNOP (Di-n-octyl phthalate), DIDP (Di-isodecyl phthalate), BBP (Butyl benzyl phthalate).

The trimellitic acid ester group includes TOTM (Tri-ethylhexyl trimellitate), TINTM (Tri-isononyl trimellitate), and TIDTM (Tri-isodecyl trimellitate).

The phosphoric acid ester group includes TCP (Tri-cresyl phosphate), TOP (Tri-ethylhexyl phosphate), CDP (Cresyl diphenyl phosphate).

The epoxy ester group are produced, first, by reacting soybean oils and linseed oils (which are unsaturated fatty acids) with a glycerine to make the unsaturated ester compounds, and then the double bonds of those esters are reacted with the hydrogen peroxide or the peracetic acid to be made into epoxies, such as, including ESO(epoxidized soybean oil) and ELO(epoxidized linseed oil).

The polyester group belongs to relatively less polymerized compounds with an average molecular weight of 1,000 to 8,000. The representative one is an adipic acid polyester group.

The aliphatic acid ester group is obtained by making reaction of various fatty acids with diverse alcohols, and is produced in a variety of types. Usually, in the reaction, the branched alcohols are preferred over the linear ones because esters made with the linear alcohols tend to be crystallized. During making esters, the level of esterification (the partial or the complete) makes difference in properties, but all esters can be used in plasticizing modifiers. It is noted that esters used in plasticizing modified recycled asphalt concrete mix should have a flashing point at or greater than 180° C.

The aliphatic acid ester group, for example, includes: i-octyl palmitate, i-octyl Stearate, octyl oleate, i-tri-decyl stearate, lauryl oleate, di-i-octyl stearate, di-i-tri-decyl adipate, pentyl glycol-di-oleate, glycerine-tri-oleate, neo-pentylglycol-di-oleate, tri-methylolpropane-tri-fatty acid ester, tri-methylolpropane-tri-laurate, tri-methylolpropane-tri-coconate, tri-methyloipropane-tri-oleate, penta-Erythritol-tetra-sebacate, penta-erythritol-tetra-fatty acid ester, penta-erythritol-tetra-oleate, tri-methyloipropane complex ester, penta-erythritol complex ester, bis-2-(2-butoxyethoxy)ethyl adipate, DOC(Dioctyl Citrate), DOM(Dioctyl Maleate), DOA(Di-2-ethylhexyl adipate), DINA(Diisononyl Adipate), DOZ(Di-2-ethylhexyl azelate), and DIDA(Di-isodecyl adipate) as well as many other fatty acid eaters, depending on types of fatty acids and alcohols used.

The cationic surfactant group includes di-ester quaternaries (esterification of fatty acid and triethanolamin), di-ester quaternaries (transesterification of plant oil and triethanol amine), imidazoline quaternaries (esterification of fatty acid and diethylenetriamine), and di-amido-amines as well as many other cationic surfactants. Also the non-ionic surfactants such as amide-types gained by reacting a palm oil and a primary amine in the ratio of 1:2 are included. One or more of the aforementioned plasticizers are used together with a warm mix additive to produce a plasticized warm mix additive.

Warm mix additives provide different functions to the modified recycled warm mix asphalt from plasticizers. They are largely divided into waxes, water blowing agents, and chemical blowing agents.

Wax-type warm mix additives usually have melting points beyond which their viscosity drastically decreases to lower the viscosity of an entire binder, but below which they get crystallized to behave like solids. The excessive use of wax-type additives increases brittleness of binders below the melting temperature and thus directly affects pavement cracks.

Water and chemical blowing agents form bubbles inside an asphalt binder and they provide lubrication effect upon collapse of bubbles when an external force is applied. When all bubbles are eliminated, no lubrication effect exists with none of the viscosity-reduction. Even though some bubbles remain in the binder, lubrication is ineffective if the asphalt binder becomes solidified due to cooling. The lubrication effect of a blowing agent hardly affects properties of an asphalt binder itself.

An effective warm mix additive can be obtained through the design of an ideal plasticized warm mix additive with excellent properties, by taking into consideration the aforementioned characteristics of a plasticizer, a wax, and a blowing agent. Well designed plasticized warm mix additives can effectively lower the production temperatures of modified recycled asphalt concrete mixes while they maintain the desired pavement performance properties.

A wax group includes paraffin wax, micro-crystalline wax, montan wax, Saesol wax, Carnauba wax, PE-wax, EVA-wax, PP-wax, hydrogenated castor oil, coumaron-inden resin, hardened castor oil, aliphatic petroleum resin, aromatic petroleum resin, aliphatic-aromatic petroleum resin, 12-hydroxy stearate, lauric amide, ethylene-bis-stearamide, stearic acid amide, oleic acid amide, erucic acid amide. N-oleic stearic acid amide, N-stearic stearic acid amide, N-stearic erucic amide, D-heptane decyl ketone (stearon: CH₃(CH₂)₁₆—CO—(CH₂)₁₆CH₃), pine tree tar, its resin, its resin salt, and their mixtures containing more than one of the above mentioned waxes.

A water blowing agent, capable of evaporating water vapor (H₂O) at 100° C. and forming foam inside an asphalt binder, includes water sprayed on aggregates, inorganic powder containing water (zeolite, bentonite, silica gel, clay, mica, calcium chloride, etc), magnesium hydroxide, calcium hydroxide, aluminum hydroxide, water-containing filler, crushed sand, or natural sand, emulsifier (EVA-emulsifer, acrylic emulsifier, cationic, anionic, non-ionic emulsified asphalt, etc.), surfactants containing water (cationic, anionic, and non-ionic), latex (SBR, NBR, isoprene, natural rubber), water-soluble polymer solutions [CMC(Carboxy-Methy-Cellulose), PAA(Polyacrylamide), PEO(Polyethylene Oxide), PVA(Polyvinylalcohol), polyvinylacetate, glycol and all their mixtures.

Another type of blowing agents, called chemical blowing agents, can generate CO₂ or NO₂ at or higher than a foaming temperature and form foam inside an asphalt binder. With a foaming point above 135° C., chemical blowing agents cannot function during the production period that is below 135° C. Therefore, the present invention includes all chemical blowing agents with a foaming point below 135° C. Such chemical blowing agents include azo-dicarbon-amide, modified azo-dicarbon-amide, azo-bis-isobutyro-nitrile RAZDN)(CH3)₂(CN)C—N═N—C(CN)(CH3)₂], N′-Dimethy-N, N′-dinitroso-terephthalamide (NTA), [(C6H4)-[Con(CH3)-NO]2], sodium bicarbonate, ammonium bicarbonate and their mixtures. Since those chemical blowing agents may generate pollution, it is suggested to use only a small amount enough to foam bubbles inside an asphalt binder, and CO₂-based agents are better to use than NO₂-based ones due to less harmfulness.

The plasticizer content in each plasticized warm mix additive depends on viscosity of a recycling modifier to be plastizied; the higher is the viscosity, the more is the plasticizer needed. Plasticizers range from 0.1 to 1.0 in parts by weight; below 0.1 parts by weight, it has little effect of plasticizing, while above 1.0 part by weight, it excessively lowers viscosity of a recylcling modifier and weakens modification effect too much. The warm mix additive decreases viscosity of asphalt binders, and values between 0.1 and 1.0 in parts by weight are commonly used. Below 0.1 parts by weight, the additive has little effect, while the content more than 1.0 part by weight brings too much brittleness to asphalt binders that can cause earlier cracking.

The adding amount of a plasticized warm mix additive, that is the sum of the plasticizer and the warm mix additive, ranges from 0.1 to 1.0 part by weight. If a plasticized warm mix additive selected from this range is considered to be 100 wt %, a plasticizer is chosen below 100 wt % and a warm mix additive fills the rest to make 100 wt % in a total. If the amount of the plasticized warm mix additive becomes lower than 0.1 parts by weight, the additive will have little effect and if it becomes above 1.0 part by weight, the viscosity of the modified recycled asphalt binder becomes too low. This may cause serious pavement performance problems such as pavement rutting or fatigue cracking.

### Advantages

First, this invention uses RAP as a major portion of a material composition with little or no virgin materials in the contrast to the existing recycled hot mix using a small amount of RAP with a large portion of virgin mixes. Several benefits of using more RAP wastes are known such as eliminating RAP accumulation, saving virgin material costs, reducing environmental pollution and protecting natural aggregate resources, etc.

Second, this invention makes possible to produce a high-quality recycled mix by using a recycling modifier, even better than virgin modified mixes and further better than virgin straight asphalt mixes. However, the existing recycled asphalt pavement has rarely been used on major roads, because the poor quality often causes performance problems (such as various cracks and rutting) that result to the early termination of the pavement life. In the contrary, the invented technology having high quality of recycled pavements extends the life cycle of pavements and drastically reduces the maintenance cost.

Third, the present invention contains the effective warm mix function for modified asphalt mixes holding high viscosity by using the plasticized warm mix additives. This warm mix feature lowers the production temperature more than 30° C. compared to the hot mix asphalt. Lowering the production temperature more than 30° C. helps reducing toxic gas emission, saving production fuels, preventing excessive oxidative aging, permitting earlier traffic opening and enabling construction at relatively low temperature and far away sites.

Fourth, the compositions suggested by the present invention can produce the modified, recycled, warm mix asphalt possessing a high quality which can be widely used in the wearing course, the surface layer, the intermediate layer and the base layer of major roads (i.e., expressways, urban roads, industrial roads, highways, suburban roads, etc.), bridges, parking lots, airport pavements, and truck loading and unloading areas, etc.

### Description of Embodiments

### EXAMPLE 1

The 3 parts by weight of SBS, the 2 parts by weight of the phosphoric acid polymer, the 0.5 parts by weight of DOP, the 1 part by weight of the stearic acid, and the 1.5 parts by weight of the micro-wax were placed in a mixer, and they are mixed for about 30 minutes at 130° C. to make a plasticized warm mix recycling modifier. This recycling modifier was made in the form of fine particles. Then, the 95.0 parts by weight of RAP that has a dense-graded distribution with a maximum particle size of 19 mm are placed in an oven at 130° C. for an hour. Next, the 1.2 parts by weight of the warm mix recycling modifier made above, the 3.8 parts by weight of asphalt binder, and the 95.0 parts by weight of RAP in the oven at 130° C. are placed in a 130° C. mixer, and are mixed for 3 minutes to produce a modified, recycled warm mix asphalt sample.

To test the quality of the modified recycled warm mix asphalt sample made, the following tests are performed: The 1100 grams of the mix sample heated to 130° C. in the oven are placed in a Marshall mold with an inner diameter of 101.6 mm and a height of 100 mm, and are compacted by the Marshall compaction-stroke 50 times on both sides of the sample mold. This makes a Marshall specimen with a diameter of 101.6 and a height of 63.5. The procedures to make the specimen are repeated to make the similar 18 specimens. After they are cured at the room temperature for a day, then the Marshall Stability tests are carried out for three specimens to find out Stability and Flow value of those specimens.

In addition, an indirect tensile strength (ITS) test is conducted to examine the characteristic behaviours of the pavement structure. For this purpose, another three Marshall specimens made above are prepared by storing them in the temperature-controlled oven at 25° C. for three hours before the test. Then the indirect tensile load is applied at a rate of 58 mm/min.

To test rut-resistance of the modified recycled warm mix asphalt, the 12 kilograms of the modified recycled warm mix asphalt made previously are placed in a lab wheel tracking mold at 130° C. and are compacted at a rate of 17-23 passes/secs by repeatedly passing a pressurized compaction roller with a diameter of 46 cm on the mix to produce a test specimen with a dimension of 30 cm×30 cm×5 cm. After the test specimen made is placed at room temperature more than 18 hours, it is cured in the temperature-controlled oven at the test temperature of 60° C. for 6 hours. Deformation is measured at the specified numbers of roller passes, when the repeated pressure of the wheel tracking roller (5.6 kgf/cm²) is applied to the compacted specimen at 60° C. with the speed of 42 passes per minute. The traveling distance of the wheel roller is 23 cm, the total run-time is 60 minutes, and the width and the diameter of the wheel tracking roller are 5 cm and 20 cm, respectively. From the test data obtained, the Dynamic Stability of the specimen is evaluated as the reverse value of the deformation slope (defined as deformation difference measured at 40 and 60 minutes divided by difference of the number of the roller passes at two specified times).

To measure the abrasive resistance of the modified RAP-recycled warm mix asphalt under a cold environment by using a chain friction, a labeling test is conducted. The procedure to make specimens is identical to the above Dynamic Stability Testing. The table installed by the test specimen is rotated at the speed of 5 rpm. At the same time, a wheel with a diameter of 250 mm and a width of 100 mm equipped with 12 chains is also rotated at 200 rpm directly above the table and then it slowly comes down to touch the specimen on the table while the specimen rotates in the opposite direction. The chains attached on the wheel wear out the surface of the specimen upon contact, and the amount of the abrasion is measured.

[Table 1] shows the test results obtained from the above experiments, and they are compared to the virgin hot mix asphalt.

TABLE 1

| | Virgin | Modified RAP- | |
|---|---|---|---|
| | Hot Mix | Recycled Warm | |
| Test Item | Asphalt | Mix Asphalt | Unit |
| Marshall Stability | 1150 | 1820 | kgf |
| Flow Value | 32 | 48 | 0.1 mm |
| Indirect Tensile | 1.3 | 1.7 | KN |
| Strength | | | |
| Dynamic Stability | 700 | 4300 | Number of passes |
| (Wheel running test) | | | required for 1 mm |
| | | | deformation |
| | | | per minute |
| Labeling Resistance | 4.0 | 2.8 | Abrasion % |

Keep in mind that the production temperature of the modified RAP-recycled warm-mix asphalt is 130° C. which is 30° C. lower than that of the virgin hot mix asphalt which is 160° C. This indicates that the modified recycled warm-mix asphalt can be produced at 30° C. lower than the conventional hot mix that will save production fuel costs. As shown in [Table 1], the modified recycled warm mix asphalt using a recycling modifier of this invention displays improved values in Marshall Stability, Flow Value, Indirect Tensile Strength, and Dynamic Stability, and Abrasion Resistance. In general, this invention offers a recycled mix 95.0 parts by weight of RAP with much improved mechanical properties and durability.

The high Marshall and Dynamic Stability of the modified recycled warm mix asphalt compared to the virgin hot mix asphalt as shown in [Table 1] imply better resistance to the pavement rutting. The high flow value and indirect tensile strength indicate improved pavement crack resistance, and the lower abrasion value means the better adhesion of particles with the modified recycled asphalt binder and thus the less aggregate getting loosed as the result of the surface wearing.

The above test results prove that the modified RAP-recycled warm mix asphalt made from solely RAP without any virgin materials, suggested by this invention, shows excellent physical properties, and can be used as a new desirable paving material.

### EXAMPLE 2

After the RAP with the maximum particle size of 19 mm is sieved by using the 2.3 mm sieve, the 30 parts by weight of the sieve-remains and the 20 parts by weight of the passings are mixed together and put in the stainless steel container. The 44.7 parts by weight of new aggregates with a dense-graded distribution are placed in another stainless steel container. After both containers are pre-heated in an oven at 135° C. for 2 hours, they are poured in a mixer heated at 135° C.

The 0.6 parts by weight of LOPE (Low Density Polyethylene) and the 0.4 parts by weight of a natural rubber solution (50 wt % solution), the 0.12 parts by weight of DOA (Dioctyladipate), the 8 parts by weight of an emulsified asphalt (50 wt % solution), the 0.18 parts by weight of Carnauba wax are all placed in the same mixer. Another modified, RAP-recycled warm mix asphalt specimen proposed in this invention is produced by mixing the content in the mixer at 130° C. for 3 minutes. According to the method described in Example 1, test specimens of this mixture are made at a warm temperature (130° C.) and are hardened at room temperature for a day. Physical properties of those specimens are measured and exhibited in [Table 2].

TABLE 2

| | Virgin | Modified | |
|---|---|---|---|
| | Hot Mix | Recycled Warm | |
| Test Item | Asphalt | Mix Asphalt | Unit |
| Marshall Stability | 1150 | 1650 | kgf |
| Flow Value | 32 | 42 | 0.1 mm |
| Indirect Tensile | 1.3 | 1.8 | KN |
| Strength | | | |
| Dynamic Stability | 700 | 2800 | Number of passes |
| (Wheel running | | | required for 1 mm |
| test) | | | deformation |
| | | | per minute |
| Labeling test | 4.0 | 3.2 | Abrasion % |

In Example 2, unlike Example 1, the 50 parts by weight of RAP and the 44.7 parts by weight of the virgin asphalt mix are used to make the modified recycled warm mix asphalt. A recycling modifier and a plasticized warm mix additive different from Example 1 are used in Example 2. All constituents are put separately in the mixer before mixing to make a modified recycled warm mix asphalt specimens. According to tests performed by using specimens made, the measured properties shown in [Table 2] are slightly lower than those in Example 1. However, the modified recycled warm mix asphalt herein also show far superior properties, compared to those of the virgin hot mix asphalt.

### EXAMPLE 3

The 70 parts by weight of RAP with a maximum particle size of 19 mm having an arbitrary particle gradation and the 28.5 parts by weight of virgin hot mix asphalt with a maximum particle size of 19 mm having a flow-resistant particle gradation are pre-heated in the oven at a 130° C. for 2 hours.

The said 70 parts by weight of RAP and the 28.5 parts by weight of the virgin asphalt mix; the 0.5 parts by weight of the polybutene and the 0.3 parts by weight of the crumb rubber; the 0.12 parts by weight of the DOP; the 0.5 parts by weight of the engine waste oil; and the 0.08 parts by weight of the azo-compound are all placed in a mixer. They are mixed at 135° C. for about 5 minutes, and the modified recycled warm mix asphalt sample is manufactured. According to the procedures described in Example 1, specimens of the said mix sample are made and they get hardened at room temperature for a day. Physical properties of those specimens are measured by the test methods described in Example 1, and the results are shown in [Table 3].

TABLE 3

| | | Modified | |
|---|---|---|---|
| | Virgin | Recycled | |
| | Hot Mix | Warm Mix | |
| Test Item | Asphalt | Asphalt | Unit |
| Marshall Stability | 1150 | 1750 | Kgf |
| Flow Value | 28 | 38 | 0.1 mm |
| Indirect Tensile | 1.3 | 1.7 | KN |
| Strength | | | |
| Dynamic Stability | 700 | 3600 | Number of passes |
| (Wheel running test) | | | required for 1 mm |
| | | | deformation per minute |
| Labeling test | 4.0 | 3.1 | Abrasion % |

[Table 3] shows that the 70 parts by weight of RAP and the 28.5 parts by weight of the virgin asphalt mix are succeeded in producing a modified recycled warm mix asphalt by adding the recycling modifier, the cohesive agent, and the plasticized warm mix additive. The recycling modifier turns out to provide far superior properties to the recycled mix over the virgin hot mix asphalt. Example 1 has shown that using RAP alone without any virgin asphalt mix can produce an excellent paving material. This is the ideal situation. However, in cases of the RAP shortage, the virgin asphalt mix must be also used together to produce the modified recycled warm mix asphalt. This is why Examples 2 and 3 are demonstrated to produce such a mix for the case of the insufficient RAP available.

[Keywords] Reclaimed Asphalt Pavement, Cohesive Agents, Recycling Modifiers, Plasticised Warm Mix Additives, Reinforcing Agents, Modified RAP-Recycled Warm Mix Asphalt, etc.

1. Compositions of modified RAP-recycled warm mix asphalt are characterized to include 100 parts by weight of mixed asphalt concrete mix of various particle-size distribution below the maximum size of 50 mm, 0.1 to 8.0 parts by weight of cohesive agents, 0.3 to 2.0 parts by weight of recycling modifiers and 0.1 to 1.0 parts by weight of plasticized warm mix additives.

2. Compositions of a modified RAP-recycled warm mix asphalt according to claim 1, wherein a mixed asphalt concrete mix, composed of 100 wt % by summing the weight of the RAP(Reclaimed Asphalt Pavement) below 100 wt % and the weight of a virgin asphalt concrete mix below 100 wt %, can have one of aggregate gradations among dense-graded aggregates, fine- or coarse-graded aggregates, microgranular aggregates, Superpave aggregates, porous aggregates, gap-graded aggregates, SMA (Ston Matrix Aggregates), open-graded aggregates and arbitrary gradations, but whose gradations can be met by adjusting the particle sizes of the said RAP and the virgin asphalt concrete mix, and whose maximum particle size is below 50 mm for a base layer, below 38 mm for an intermediate layer, below 26 mm for a surface layer, below 13 mm for a surface wearing course, below 2.5 mm for a surface slurry layer or a crack sealer, and below 0.6 mm for thin surface coating, but all these sizes arbitrarily changed.

3. Compositions of a modified RAP-recycled warm mix asphalt according to claim 1, wherein a cohesive agent is an asphalt binder or any chemical compound highly compatible with an asphalt binder whose viscosity is equal to or lower than the asphalt binder at high-temperatures (100° C. above) and whose flash point is greater than 180° C., which includes one or more of the selected materials; hydrocarbon oils, aromatic processing oils, aliphatic processing oils, aliphatic-aromatic mixed processing oils, heavy oils, various industrial and commercial rejuvenators, cationic asphalt emulsions, anionic asphalt emulsions, nonionic asphalt emulsions, BTX (Benzen Toluene Xylene) oils, asphalt binders for road pavements, cutback asphalt primers, organic acids (adipic acids, fumaric acids, oxalic acids, maleic anhydrides, stearic acids, oleic acids, palmitic acids, terephthalic acids, lauric acids, etc.), organic acid salts, organic amines, MMA (methylmethacrylate) solutions, unsaturated polyester, animal oils (cow, pig, fish oils, etc.), vegetable oils (bean, corn, sesame, perilla, coconut seed, coconut cake, palm, palm cake, palm sludge, linseed oil, cotton seed oil, wool plannel cator oil, etc.), animal-vegetable oil mixture, castor oil, mineral oil, bunker C oil, bunker B oil, bunker A oil, glycerol, grease, waxes, waste and refined industrial oils (lubricants, rolling oils, heat transfer oils, engine oils), refined and wasted shipping motor oils, refined and wasted compressor oils, phosphoric acid, wasted motor oils, and all their mixtures, etc.

4. Compositions of a modified RAP-recycled warm mix asphalt according to claim 1, wherein a recycling modifier is composed of 100 wt % by summing the weight of an elastic polymer below 100 wt % and the weight of a viscous polymer below 100wt %, provided that a certain part by weight of this recycling modifier can be used in the range of 0.3 to 2.0 parts by weight either in the form of a solid whose particle diameter is 3 mm or below such as fine particles or powders, or in the form of a liquid dispersion whose particle diameter is 0.5 mm or below, and the recycling modifier can be added to the mixture, independent or dependent of a cohesive agent.

5. Compositions of a modified RAP-recycled warm mix asphalt according to claim 4, wherein the said elastic polymers include thermoplastic elastomers and rubbers including SBS(Styrene-Butadiene-Styrene), SBR(Styrene-Butadiene Rubber), SEBS(Styrene-Ethylene-Butadiene-Styrene), PU(Polyurethane), SIS(Styrene-Isoprene-Styrene), ABR(Acrylobutadiene Rubber), polychloroprene rubber, butyl rubber, natural rubber, crumb rubber, NBR (Nitril Butadiene Rubber), isoprene rubber, EPDM (Ethylene-Propylene-Diene-Monomer Rubber), butadiene rubber, and waste rubber powder, and mixtures containing one or more of the aforementioned elastic polymers.

6. Compositions of a modified RAP-recycled warm mix asphalt according to claim 4, wherein the viscous polymers include all thermoplastic polymers, such as high-density polyethylene (HDPE), low-density polyethylene (LDPE), linear low-density polyethylene (LLDPE), polypropylene (PP), co-polypropylene (CPP), petroleum resin, polyvinylbutyral, polystyrene (PS), high impact polystyrene (HIPS), low molecular weight polyamide, elvaloy, polyvinylacetate (PVA), ethylene-vinyl acetate (EVA), polybutene(PB), acrylic latex, nitro-cellulose, ethyl cellulose, polyphosphoric acid, acrylo-nitril-butadiene Copolymer (ABS), Kopel, rosin and mixtures containing one or more of the aforementioned viscous polymers.

7. Compositions of a modified RAP-recycled warm mix asphalt according to claim 1, wherein a plasticized warm mix additive is characterized to be 100 wt % by adding the weight of a plasticizer which is below 100 wt % to the weight of a warm mix additive which is below 100 wt %, provided that the plasticized warm mix additive occupies from 0.1 to 1.0 part by weight of the composition.

8. Compositions of a modified RAP-recycled warm mix asphalt according to claim 7, wherein plasticizers defined as ester compounds produced by reacting organic acids with alcohols (or an amins), whose flash point should be above 180° C. can be classified as many different types. For instance, the phthalate esters including DOP(Di-2-ethylhexyl-phthalate), DBP(Di-butyl-phthalate), DINP(Di-isononyl phthalate), DNOP(Di-n-octyl phthalate), DIDP(Di-isodecyl phthalate), BBP(Butyl benzyl phthalate) and their mixtures; the trimellitic acid esters including TOTM(Tri-ethylhexyl trimellitate), TINTM(Tri-isononyl trimellitate), TIDTM(Tri-isodecyl trimellitate) and their mixtures; the phosphoric acid esters including TCP(Tri-cresyl phosphate), TOP(Tri-ethylhexyl phosphate), CDP(Cresyl diphenyl phosphate) and their mixtures; the epoxy esters including ESO(epoxidized soybean oil), ELO(epoxidized linseed oil), and their mixtures; the polyesters with low degrees of polymerization (whose average molecular weight ranges between 1,000 and 8,000) including adipic acid polyester; the aliphatic acid esters including i-Octyl palmitate, i-Octyl Stearate, i-Octyl Oleate, i-tri-Decyl Stearate, Lauryl Oleate, di-i-Octyl Stearate, di-i-tri-Decyl Adipate, Pentyl Glycol-di-Oleate, Glycerine-tri-Oleate, Neo-Pentylglycol-di-Oleate, tri-Methylolpropane-tri-fatty acid ester, tri-Methylolpropane-tri-Laurate, tri-Methylolpropane-tri-Coconate, tri-Methylolpropane-tri-Oleate, penta-Erythritol-tetra-Sebacate, penta-erythritol-tetra-Fatty Acid Ester, penta-erythritol-tetra-Oleate, tri-Methylolpropane Complex Ester, penta-Erythritol Complex ester, bis-2-(2-butoxyethoxy)ethyl adipate, DOC(Dioctyl Citrate), DOM(Dioctyl Maleate), DOA(Di-2-ethylhexyl adipate), DINA(Diisononyl Adipate), DOZ(Di-2-ethylhexyl azelate), DIDA(Di-isodecyl adipate) and their mixtures, and the surfactants made by reacting fatty acids with amines including; di-esters (esterification of fatty acids and triethanolamines), modified di-esters (trans-esterification of plant oils and triethanol amines), imidazolines and their mixtures.

9. Compositions of a modified RAP-recycled warm mix asphalt according to claim 7, wherein warm mix additives refer to waxes or water blowing agents or chemical blowing agents among which waxes include paraffin wax, micro-crystalline wax, montan wax, Saesol wax, Carnauba wax, PE-wax, EVA-wax, PP-wax, hydrogenated castor oil, hardened castor oil, aliphatic petroleum resin, aromatic petroleum resin, aliphatic-aromatic petroleum resin, 12-hydroxy stearate, lauric amide, ethylene-bis-stearamide, stearic acid amide, oleic acid amide, erucic acid amide, N-oleic stearic acid amide, N-stearic stearic acid amide, N-stearic erucic amide, D-heptane decyl ketone (stearon: CH₃(CH₂)₁₆—CO—(CH₂)₁₆CH₃), pine tree tar, resin, resin salt, and their mixtures; or water blowing agents capable of evaporation at 100° C. include water, inorganic powder containing water (zeolite, bentonite, silica gel, clay, mica, calcium chloride, etc), magnesium hydroxide, calcium hydroxide, aluminum hydroxide, fillers containing water, crushed sand containing water, or natural sand, emulsifier (EVA-emulsifer, acrylic emulsifier, cationic, anionic, non-ionic emulsified asphalt, etc.), surfactants containing water (cationic, anionic, and non-ionic), latex (SBR, NBR, isoprene, natural rubber), water-soluble polymer solutions [CMC(Carboxy-Methy-Cellulose), PAA(Poly-Acryl-Amide), PEO(Poly-Ethylene-Oxide), PVA(Poly-Vinyl-Alcohol), poly-vinyl-acetate, glycol] and their mixtures; or chemical blowing agents capable of foaming below 135° C. include azo-dicarbon-amide, modified azo-dicarbon-amide, azo-bis-isobutyro-nitrile [(AZDN)(CH3)₂(CN)C—N═N—C(CN)(CH3)₂], N′-Dimethy-N, N′-dinitroso-terephthalamide (NTA), [(C6H4)-[Con(CH3)-NO]2], sodium bicarbonate, ammonium bicarbonate and their mixtures.

10. Compositions of a modified RAP-recycled warm mix asphalt according to claim 1, wherein 0.1 to 2.0 parts by weight of reinforcing materials consisting of one or more among inorganic powder, organic powder, and short fiber can be added to enhance mechanical properties of the modified recycled warm mix asphalt, of which the inorganic and the organic powders contain calcium carbonate powder, limestone powder, fine aggregate, waste toner, silica, bentonite, zeolite, clay, mica, carbon black, steel slag powder, furnace slag powder, plastic refuse-derived fuel (RDF), flammable refuse-drived fuel (RDF), biomass powder, organic and inorganic color pigments, paper powder, waste plastic powder, sawdust, various cements, fly ash, gypsum powder, clay powder, quicklime, slaked lime, and their mixtures, and of which short fibers consist of nylon short fibers, polyester short fibers, PE short fibers, PP short fibers, short carbon fibers, short cellulose fibers, short glass fibers, asbestos fibers, and their mixtures.
